(19) United States
(12) Patent Application Publication
(10) Pub. No.: US 2026/0268235 A1
(43) Pub. Date: Sep. 10, 2026

(54) ELECTROPHORETIC OSCILLATORS, SYSTEMS AND METHODS

(71) Applicant: PURDUE RESEARCH FOUNDATION, West Lafayette, IN (US)

(72) Inventors: Alex Chortos, West Lafayette, IN (US); Michael Musa Sotzing, West Lafayette, IN (US)

(21) Appl. No.: 19/452,088

(22) Filed: Jan. 16, 2026

Related U.S. Application Data
(60) Provisional application No. 63/746,165, filed on Jan. 16, 2025.

(51) Int. Cl. G06N 99/00

(52) U.S. Cl. CPC G06N 99/007

(57) ABSTRACT

Oscillating systems and methods are disclosed. Embodiments include two electrodes placed close together, a dielectric fluid filling the gap between the two electrodes, and one or more particles capable of carrying a charge (and/or discharging a charge) within the dielectric fluid. Some embodiments apply a voltage difference to the two electrodes, including migration of the one or more particles to the other electrode, and in some embodiments back and forth between the electrodes. At least one embodiment measures the movement of the particles, such as by electrical and/or visual (e.g., photoelectric) means, which can be used for electrical computations. Particles of differing sizes can result in randomized motions, which can be used in certain applications such as encryption or random number generators. Embodiments include encryption devices, random number generators, neuromorphic computing, reservoir computing, and spintronic computing. Embodiments operate at much lower baseline voltages than conventional oscillators.

This application claims the benefit of U.S. Provisional Application No. 63/746,165, filed 16 Jan. 2025, the entirety of which is hereby incorporated herein by reference.

### FIELD

Embodiments of this disclosure relate generally to oscillators, such as electrophoretic oscillators, and systems and methods of utilizing electrophoretic oscillators.

### BACKGROUND

Computational problems are becoming increasingly complex and traditional computing hardware and techniques are becoming incapable of solving these complex problems without using exponentially larger platforms. Many current computing techniques rely on coupling numerous oscillators together and measuring various outputs, such as the rate of convergence of a solution or the degree of synchronization between numerous oscillators. Some approaches attempt to utilize traditional CMOS (Complementary Metal-Oxide-Semiconductor) architecture to create Ising-like computers, which the inventors of the current disclosure realized still have many of the issues seen in simulated computational approaches. Others have approached the problem with biological systems, such as by coupling multiple cardiac pacemaker cells to form individual oscillators.

The inventors of the present disclosure realized that at least one important component needed to solve these complex problems is a stable computer oscillator, and especially one that draws little power. And, while some of the known approaches may have improved the speed of convergence for a solution, the inventors of the present disclosure realized that problems still exist with these approaches, such as excessive power consumption, excessive cost and difficulties with scalability, and that improvements in the ability of computational devices to solve complex computational problems and other functions are needed.

Certain preferred features of the present disclosure address these and other needs and provide other important advantages.

### SUMMARY

Embodiments of the present disclosure provide electrophoretic oscillators, systems and methods, including systems and methods utilizing electrophoretic oscillators.

Additional embodiments of the present disclosure provide improved electrophoretic oscillators, systems and methods.

Further embodiments provide electrophoretic micro-discharge oscillators.

Still further embodiments provide computing and bioelectronics applications of electrophoretic oscillators, including electrophoretic micro-discharge oscillators.

When particles suspended in a liquid are exposed to a voltage, the particles can spontaneously oscillate between the two electrodes, which may be referred to as contact charge electrophoresis (CCEP). It was realized by the inventors of the present disclosure that this strategy can assist in creating low power consumption computational devices, thereby resulting in the ability to run complex computations with lower power consumption. It was also realized by the inventors that this strategy can produce a unique waveform for the current consumption that resembles action potentials observed in biological computation, thereby enabling machine-organism interfacing.

Embodiments of the present disclosure include CCEP device geometries that achieve low voltage and low power operation. Further embodiments include device structures in which oscillators are coupled electronically for computing. Advantages of the disclosed multi-state artificial computing platform include low power consumption, on-demand adaptability, and low-cost manufacturing. Many of these advantages address shortcomings of other state-of-the-art computing architectures. Potential uses for embodiments include applications in bio-integrated systems and next-generation computation platforms.

Embodiments of this disclosure include oscillators (for example, electrophoretic oscillators), systems of oscillators, methods of manufacturing oscillators, methods of operating and/or using oscillators, methods of performing calculations using oscillators, methods of generating random numbers, methods of using oscillators for encryption, and/or methods of using oscillators in electronic devices.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 depicts a CCEP oscillation demonstrated with positively (+) and negatively (−) charged electrodes that charge and/or discharge a particle according to at least one embodiment of the present disclosure. The particle travels to the opposite electrode once the charge is strong enough to overcome the adhesion to the electrode and viscous forces of the surround medium. Repeated charging and discharging leads to an oscillatory motion of the particle.

FIG. 2 depicts a typical example current output of an electrode in a CCEP system.

FIG. 3 depicts a bucket brigade oscillator according to at least one embodiment of the present disclosure, and demonstrates the extension of electrodes with the use of self-assembled particles.

FIG. 4 depicts a large aspect ratio particle according to at least one embodiment of the present disclosure.

FIG. 5 is a representation of capped particles used in an oscillator according to at least one embodiment of the present disclosure.

FIG. 6 depicts a coupling of neighboring oscillators through capacitance according to at least one embodiment of the present disclosure. Coupling can be achieved through oscillator proximity, or capacitors/resistors between electrodes.

FIG. 7 depicts an example Ising machine configuration using coupled spin-state devices.

FIG. 8 depicts the oscillation of particle with 20 V stimulation in silicone oil according to at least one embodiment of the present disclosure.

FIG. 9 depicts physical memory capability of CCEP oscillators that share a liquid channel according to at least one embodiment of the present disclosure.

FIG. 10 depicts operation of a CCEP oscillator at a similar voltage and frequency as biological neurons according to at least one embodiment of the present disclosure.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” that may occur within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

Embodiments of the present disclosure include miniaturization of particle electrophoresis using micron or sub-micron size particles that can (1) be further miniaturized through “bucket chain” systems, (2) have reduced electrode adhesion forces using surface asperities, porosity, or capping, (3) have improved counter electrode attraction with large shape factor particles, and/or (4) be coupled with other oscillators through proximity-based capacitance and/or electronic (PCB-style) connections.

### Electrophoretic Oscillators

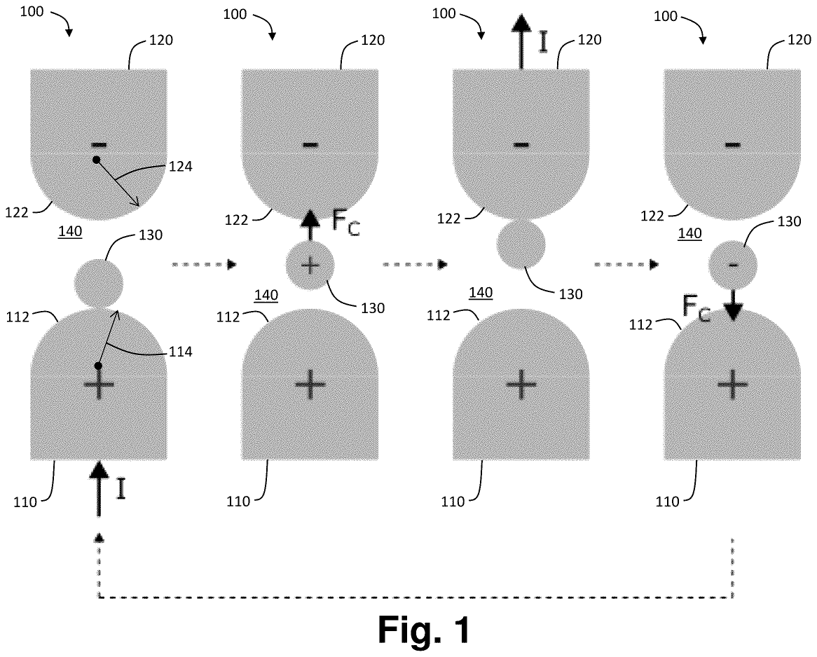

Depicted in FIG. 1 is an oscillator 100 according to embodiments of the present disclosure. Oscillator 100 is depicted at four (4) different times to illustration the operation of oscillator 100. Oscillator 100 includes a first electrode 110, a second electrode 120 and one or more particles 130. The first electrode 110 includes a first electrode tip 112 and the second oscillator includes a second electrode tip 122. The surface of first electrode tip 112 adjacent to the second electrode tip 122 defines a radius 114 (i.e., a radius of curvature). Similarly, the surface of the second electrode tip 122 adjacent to the first electrode tip 112 defines a radius 124. Filling the space between the electrode tips 112 and 122 is a medium 140, and within the medium is the one or more particles 130.

As used herein, the gap distance is the minimum distance between the electrode tips 112 and 122, i.e., the distance between the portions of the electrodes 110 and 120 that are closest to one another (i.e., the minimum distance between the surfaces of electrode tips 112 and 122).

The inter-electrode distance, however, is the distance between the locations on the electrodes 110 and 120 where the particles attach during operation. These attachment locations tend to occur where the electrical charge on the electrode surface is at a local maximum, which can correlate with the portions of the electrode tip that have the smallest radius of curvature, i.e., where the electrode tips form the sharpest points (are “pointiest”).

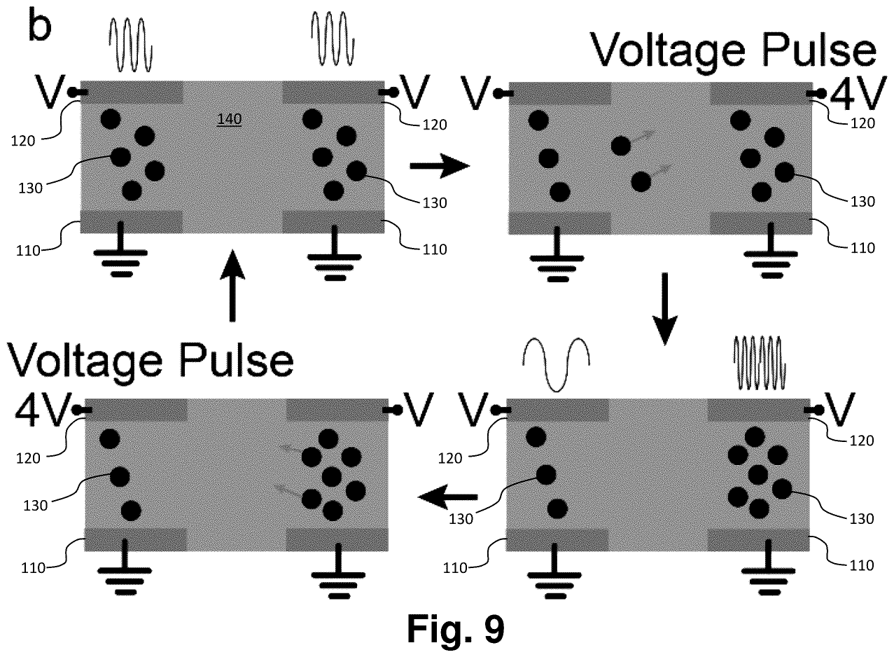

With some embodiments the inter-electrode distance does not equal the gap distance. For example, with electrodes 110/120 that have rectangular tips (e.g., a flat surface that is perpendicular to a line tracing the shortest distance between the two electrodes 110/120 and two 90 degree corners on either side of the flat surface; see, e.g., FIG. 9), the higher charge concentrations tend to occur at one or both of the 90 degree corners, which can result in the particles attaching to a 90 degree corner. And, in these embodiments the 90 degree corners are not locations where the minimum distance between the two electrodes occurs. However, in some embodiments (e.g., embodiments with rounded electrode tips, such as the electrode tips 112 and 122 depicted in FIGS. 1, 3-6, 8 and 9), the gap distance and the inter-electrode distance are equal. In other embodiments where the electrode tips 112/122 are far apart but the gap and the inter-electrode distances are not exactly equal, the gap and inter-electrode distance will nevertheless be approximately equal.

Embodiments of the present disclosure position the electrodes 110/120 sufficiently close to one another (i.e., at an inter-electrode distance sufficiently small) to facilitate migration of particles between the electrode tips 112 and 122. For example, in some embodiments the inter-electrode distance (e.g., gap distance 139) is at most ten (10) times the radius of curvature 114 and/or 124. In other embodiments, the inter-electrode distance (e.g., gap distance 139) is at most five (5) times the radius of curvature 114 and/or 124. In still other embodiments, the inter-electrode distance (e.g., gap distance 139) is at most equal to the times the radius of curvature 114 and/or 124. And, in still further embodiments, the inter-electrode distance (e.g., gap distance 139) is as short as 1/100 (one one-hundredth) the radius of curvature 114 and/or 124. In some embodiments the inter-electrode distance is between 5 μm (micrometers) and 500 μm.

In additional embodiments, the size of the one or more particles 130 (e.g., the largest dimension 133 of the one or more particles, such as shown in FIG. 4) are smaller than the gap distance 139. In some embodiments the largest dimension 133 is at most 70% the gap distance 139, while in additional embodiments the largest dimension 133 is at most 20% the gap distance 139, and in still further embodiments the largest dimension 133 is at most 5% the gap distance.

Contact charge electrophoresis (CCEP) is a mechanism wherein particles in the medium between the electrodes are charged by a first electrode 110 (an “original electrode”) that induce a coulomb attractive force between the particle and a second electrode 120 (a “counter electrode”). The use of the descriptive terms “first,” “second,” “original” and “counter” are for illustrative and explanatory purposes since, for example, at least some embodiments include first and second electrodes that are identical. One or more particles (e.g., one or more particles 130) can comprise materials that include conductive materials such as metals or carbon (e.g., carbon black), and can also include insulating materials such as polymers or even droplets of incompatible phase liquids (e.g., oils in water, or water in oil). The one or more particles 100 are suspended in a medium 140 that is typically not conductive and not a solid. The medium 140 separating the electrodes can be an insulating liquid (oil), but in some embodiments includes a gas. In some embodiments the medium 140 is a dielectric liquid, such as a linearly dielectric liquid that is neither ionically nor electrically conductive (e.g., silicon oil or mineral oil).

Using the example oscillator 100 that includes two electrodes 110/120 and a single particle 130 as depicted in FIG. 1 to describe the functioning of oscillators according to embodiments of the present disclosure function, once the coulomb force (which depends on the potential difference between the particle 130 and counter electrode 120) overcomes the adhesion force between the particle 130 and the original electrode 110, the particle 130 will travel through the medium 140 (e.g., a viscous medium) to the counter electrode 120. In some embodiments the particle 130 travels through a channel filled with the medium 140. When this occurs, the charges on the particle 130 are transferred to the counter electrode 120. The potential on the particle 130 is then similar to the potential of the counter electrode 120, resulting in an attractive force between the particle 130 and the original electrode 110, causing the particle 130 to move back toward the original electrode 110. In other words, with one electrode being positive and the other being negative, the particle 130 will switch from having a positive charge to having a negative charge and therefore oscillate back and forth between the two electrodes. The result is an oscillatory motion as demonstrated in FIG. 1, where FC is the coulomb force, I is the current that results in charging of the particle 130, and +/− are the electrode potentials. The relative charges on the two electrodes 110/120 depend, at least in part, on whether the device is operating in voltage controlled mode or current controlled mode. Moreover, minimum operating voltages of the device will typically depend on the viscosity of the medium 140, gap distance, and particle size, where minimization of any of these factors will typically result in lower oscillating voltage thresholds.

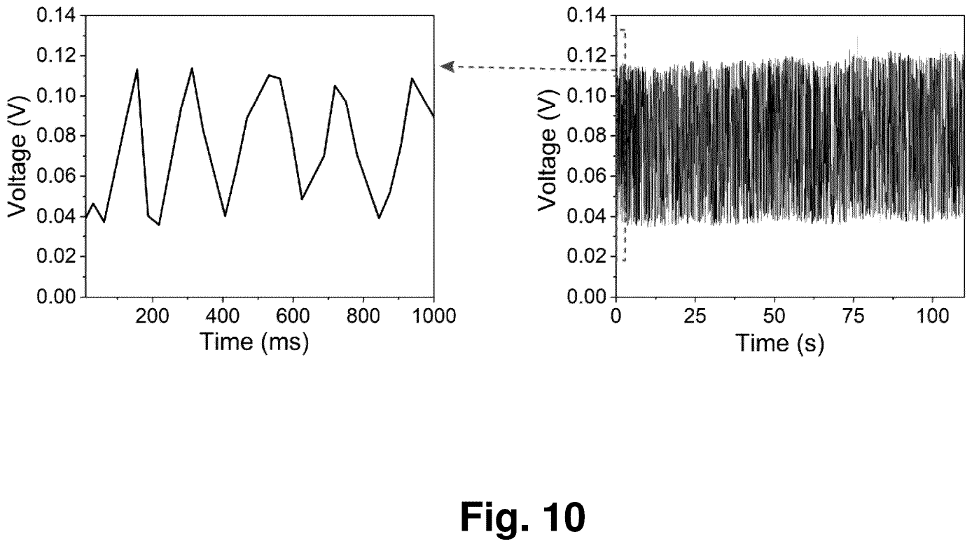

The current that charges and/or discharges the particle 130 indicates the oscillation frequency. An example depiction of the oscillation frequency of individual oscillators is shown in FIG. 10. In alternate embodiments, optical methods (e.g., photodetectors) are employed to determine the frequency and/or measure the motion of the particle(s). The oscillation frequency typically varies with the applied voltage, and target frequency ranges can be optimized by choice of medium (e.g., air, water and oil) and particle type (e.g., composition, size and shape).

Some embodiments apply a current to the electrodes 110 and 120 and measure the voltage of the electrodes 110 and 120, while other embodiments apply a voltage to the electrodes 110 and 120 and measure the current at the electrodes 110 and 120.

### Bucket Brigades

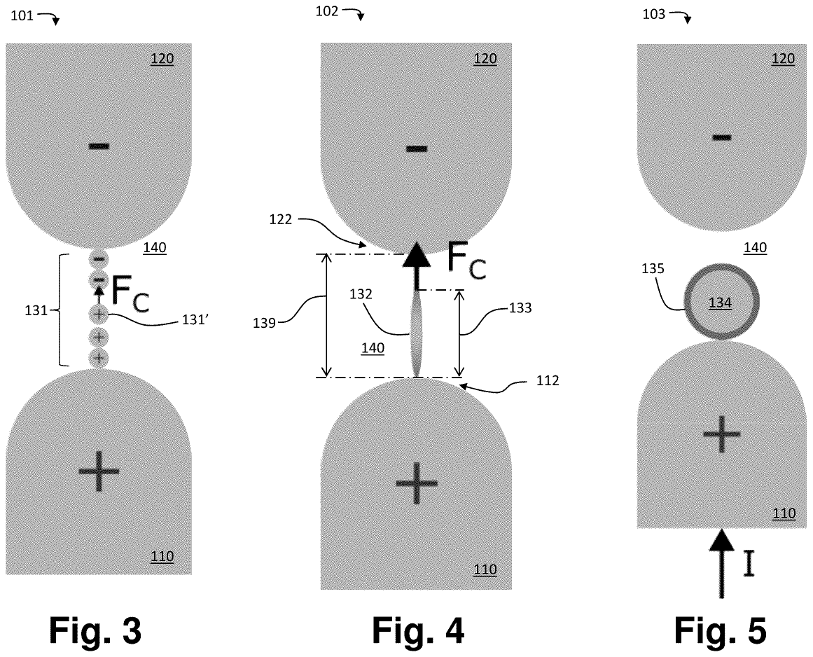

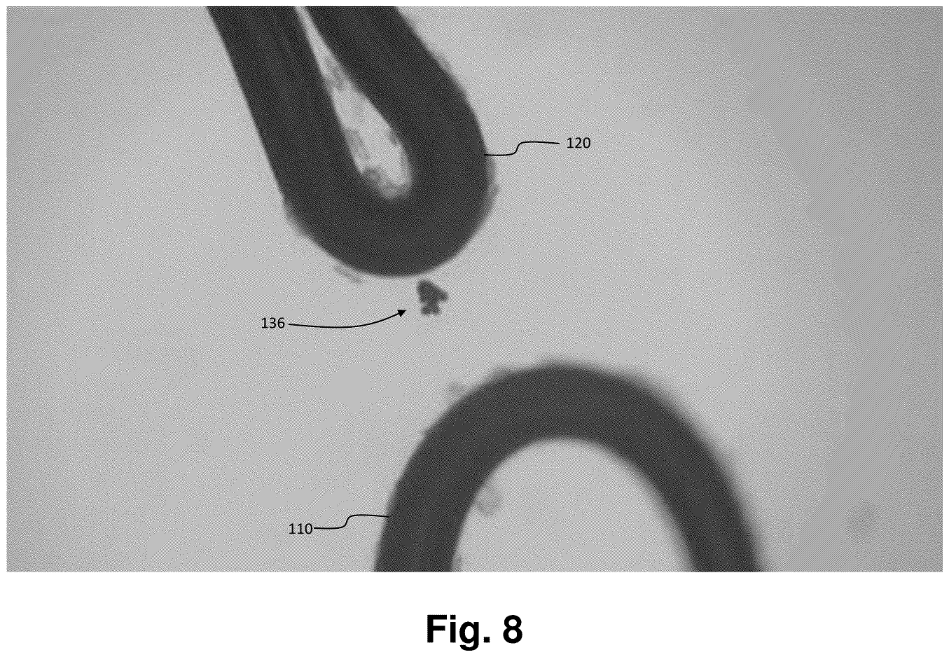

Bucket brigades have the advantages of being able to overcome the inherent limitations of lithographic processes for making electrode arrays, and is one manner of further lowering the operating voltage of the oscillators. Using FIG. 3 as an example, particles (e.g., particles 131) can self-assemble into chains between electrodes 110 and 120. At least one situation where this can occur is when electrodes 110 and 120 are highly charged, e.g., when electrodes 110 and 120 are charged more than required to move a single particle. In example embodiments with two or more particles 131 (such as five or more particles as depicted in FIG. 3), if the sum of the diameter of the particles 130 does not fully bridge the inter-electrode distance (e.g., gap distance 139), all but one of the particles 130 can act as extensions of the fixed electrodes 110 and 120. See, e.g., the two upper negative (“−”) particles 131 and the two lower positive (“+”) particles 131 that are depicted acting as example extension particles with the center particle 131′ acting as an example moving particle in FIG. 3. The center particle 131′ therefore moves a distance that is less than the gap distance. Whether a single particle 131 oscillates or a group 136 of particles 131 oscillate together (essentially acting as one large particle with a large aspect ratio, such as depicted in FIG. 8) is still being investigated and is thought to depend on the size and/or relative adhesive forces of the particles 131 within the medium 140.

Embodiments of the present disclosure apply this phenomenon to a structure with coupling and current sensing, and in some embodiments the activation voltage of oscillation is reduced to less than 10⁻¹ V ( 1/10 volts).

### Particle Shape

As indicated above, reduction of the activation voltage is a desirable characteristic which can enable prolific use of the described embodiments. Particles with non-spherical shapes (see, e.g., particle 132 in FIG. 4) are used as another manner of further lowering the operating voltage of the oscillators. In some embodiments the non-spherical particles 132 are used for directed motion of the particles in microfluidic applications, such as head-tail geometries similar to the geometry depicted in FIG. 4. In FIG. 4, particle 132 is depicted with a generally oblong shape. However, different embodiments utilize particles of different shapes, e.g., regular, irregular, rough and geometric shapes. The largest dimension of particle 132 (the portions of particle 132 that are farthest apart) is depicted as largest dimension 133, which is less than the gap distance 139 between the tip 112 electrode 110 and the tip 122 of electrode 120.

Adapting embodiments of the present disclosure to computational uses can be undertaken with the objective of reducing activation voltage. For example, particle 132 with large shape factor (e.g., a high aspect ratio, i.e., an elongated particle) will improve the attractive force of the particle 130 to the counter electrode 120. This is due, at .east in part, to particle 132 having a non-uniform electrical field on its non-spherical surface. For example, the concentration of charge on sharper (higher convexity) surfaces which means that attraction to the counter electrode 120 will be improved both by closer proximity of the particle 132 and the counter electrode 120 to one another, and by a higher local potential in the region where the particle 132 is closest to the counter electrode 120. As shown in FIG. 4, the oblong particle 132 has non-uniform charge, which is shown by the darker portions of the particle 132 at the top and bottom of the particle 132 (“top” and “bottom” being referenced to the FIG. 4 illustration) indicating the areas of greater charge. This type of particle can require lower voltage to overcome the adhesion of the particle to the similarly charged electrode with larger attractive force to the counter electrode 120.

### Particle Surface

As depicted in FIG. 5, particles (e.g., particle 134) can be encapsulated, capped, and complexed with a variety of organic and non-organic compounds 135, which is yet another manner of further lowering the operating voltage of the oscillators. Changing the surface chemistry of the one or more particles can have a significant impact on the interaction between the particle(s) and the electrode surfaces, as well as the interaction of the particle 134 with the surrounding medium 140. For example, in some embodiments a particle 134 capped with a molecule that has outward facing methyl groups can integrate better with certain types of medium, one example being silicone oil which also contains methyl groups. A particle 134 with fluorinated groups will have low surface energy and therefore reduced adhesion with the electrodes 120/130. In some embodiments, optimization of capping for particle-electrode and particle-medium interactions is used to alter the attraction of particles 134 to each other or to the electrodes 120/130, which can change the output current waveform. Additionally, embodiments where there is repulsion between the electrode surface and surface of particle 134 can reduce the threshold voltage.

### Oscillator Coupling

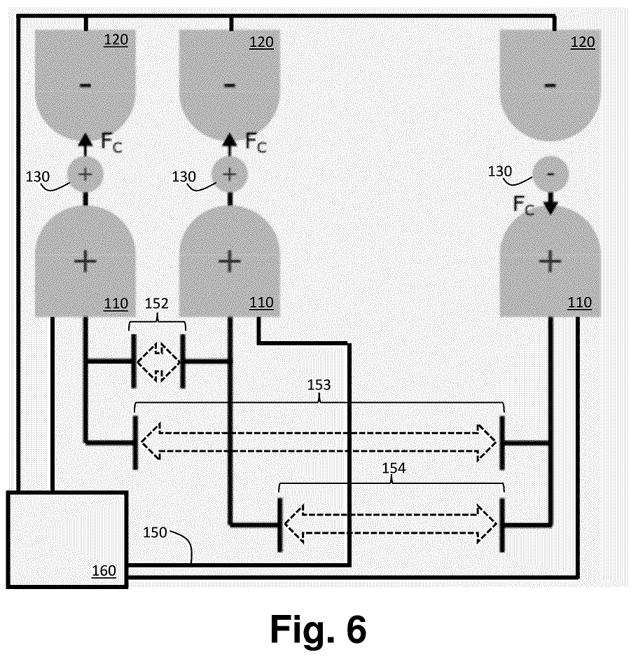

In some embodiments, the coupling of oscillators can be proximity driven (i.e., driven by the closeness of the oscillators to one another) through interparticle capacitance through a dielectric fluid medium 140. In other embodiments, coupling with tunable coupling strength is achieved by using electronic components to introduce capacitance (using, e.g., capacitors) and/or resistance (using, e.g., resistors) between electrodes 110/120. For example, FIG. 6 depicts three pairs of electrodes 110/120 with particles 130, an electric driver 160 connected to electrodes 110 and 120 (such as by electrical connections 150) to apply voltages and/or electrical currents to the electrodes 110 and 120, capacitors 152, 153 and 154 connecting electrodes 110 from different oscillators. Further embodiments couple different numbers of oscillators (e.g., 2, 4, 5, 6, etc.), and in some embodiments different pairs of coupled oscillators are coupled with different coupling strengths. For example, in the system depicted in FIG. 6, the left and center oscillators can be locked in phase while the right oscillator can maintain out-of-phase motion. Using various combinations of oscillator proximity, capacitance and resistance, embodiments can be configured to solve countless types of complex problems.

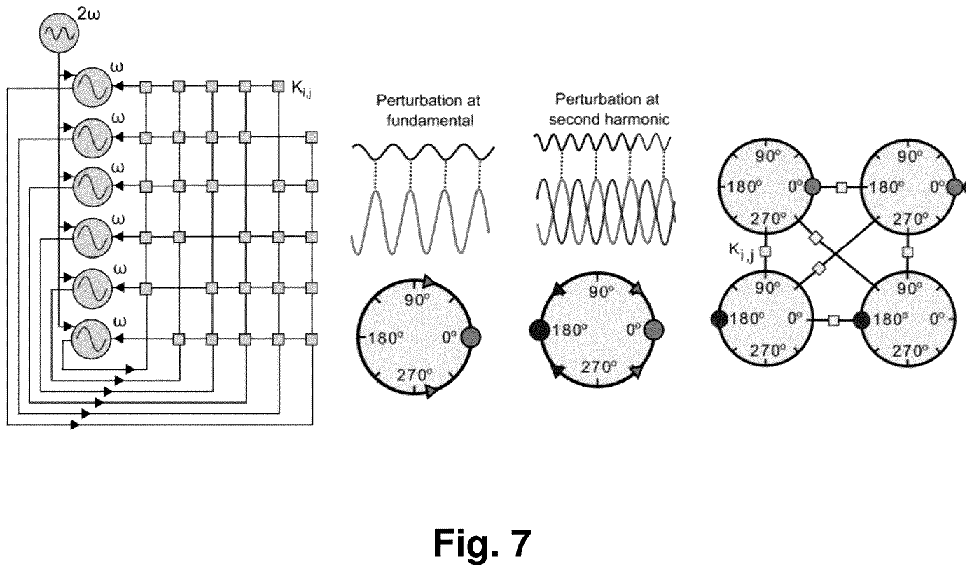

Still further embodiments utilize electrophoretic oscillators in coupled systems, for example, electrophoretic oscillators in coupled systems that rely on synchronization of oscillators to solve combinatorial problems and/or electrophoretic oscillators coupled together in configurations similar to Ising machines. An example Ising machine configuration that uses coupled spin-state devices is depicted in FIG. 7. In these embodiments the synchronization of oscillators to solve combinatorial problems with the coupling strength K_{i,j} being used to perform phase-locking between different oscillators in the network.

### Low Voltage and Low Power Operation

Although some CMOS-based systems can have the potential to mimic coupled oscillators, they exhibit high power consumption. Contact charge electrophoresis (CCEP) systems and mechanisms as disclosed herein can have inherently low power consumption than traditional systems and mechanisms. At least one limitation of prior CCEP device structures is their requirement for high operational voltages, which limits the device structures that can be used. And, while embodiments of the present disclosure are capable of operating at high voltages (e.g., operating voltages of 600 V (volts), and in some embodiments higher than 600 V), an advantage of embodiments of the present disclosure is their ability to operate at low voltages. For example, embodiments of the present disclosure operate at baseline voltages (e.g., the mean/average of voltage potentials on both electrodes 110 and 120) of 200 V (two hundred volts) or less, while further embodiments operate at baseline voltages of 20 V (twenty volts) or less, additional embodiments operate at baseline voltages of 5 V (five volts) or less, yet further embodiments operate at baseline voltages of 2 V (two volts) or less, still additional embodiments operate at baseline voltages of 1 V (one volt) or less, and still further embodiments operate at baseline voltages down to unprecedentedly low values of 0.12 V (volts) and 0.10 V (volts), which are dramatically lower than voltages used with other oscillator technologies such as ovonic oscillators and ring oscillators.

In other oscillator technologies, the power consumption is typically proportional to the size of the device. For devices made using traditional electronics manufacturing techniques (e.g., lithography), power consumption can therefore be reduced by using higher resolution (more expensive) fabrication methods. Oscillators made using thin-film electronics, which typically have feature sizes greater than 10 μm (micrometers), result in devices that are inherently large resulting in very high power consumption. In comparison, oscillators according to embodiments of the present disclosure not only have the advantage of low-cost fabrication, but also have the advantage of low power consumption that can be optimized independently of the device size.

### Reliability and Ambient Operation

Traditional solid state oscillator technologies, such as ovonic threshold oscillators and VO₂-based oscillators, have problems with drift over time, i.e., even under steady-state operation their baseline voltage and/or oscillation magnitude will change (“drift”). Since the CCEP oscillators as disclosed herein are based on simple electrostatic attraction, there has been no observable drift over time with the embodiments disclosed herein. Moreover, some oscillator technologies (e.g., quantum computers) require low temperatures to operate; however, CCEP oscillators disclosed herein can operate at ambient temperatures similar to other chip-based oscillators, do not require special cooling, and are still capable of solving problems currently solvable only with quantum computing.

### Memory and Stimuli Responsiveness

In some embodiments disclosed herein, the space between the electrodes (channels or gaps) include liquids (or gasses), which results in the ability to couple the channels together, thereby enabling the exchange of particles 130 between the channels and between the electrode pairs. This feature further enables advanced functions, which can include adaptive computing and physical memory. As shown in the sequence of depictions in FIG. 9, in some example embodiments two channels are coupled through a liquid medium 140 and the application of a voltage to one of the channels that is larger than the voltage at the adjacent channel electrically attracts particles 130 from the adjacent channel. By changing the number of particles 130 in the two channels, the operation frequency of the two channels are changed, resulting in a type of physical memory. For example, the state of the device (i.e., the number of particles associated with each oscillator) is preserved even if the voltage is removed.

Compatibility with 3D Geometries

Biological brains (e.g., human brains) have large processing capabilities that result, at least in part, from the large number of connections between neurons with each neuron connecting to up to 1000 other neurons. At least one of the features that facilitates such large number of connections in biological brains is the ability to connect with one another in three dimensions (3D). One feature of embodiments of the present disclosure is a very simple device structure and suitability for microfabrication techniques that enable 3D layouts of oscillator arrays, which can enable a high connection density. Moreover, the operational characteristics of oscillators 100 (and systems of oscillators 100 disclosed herein) is that they can be used for neuromorphic (e.g., spike-based) computing similar to biological brains.

### Computational Applications

Assemblies of devices that self-oscillate can be used to solve problems that are very computationally difficult to solve using traditional computational approaches. This has been the motivation for recent research on emerging computing platforms like simulated spintronics, CMOS-based oscillator chips, and solid-state oscillators such as VO2. However, despite this intense interest, no oscillator-based computing platform is currently available. Embodiments of the present disclosure overcome these and other shortcomings and can provide oscillator-based computing platforms that meet the needs of solving computationally difficult problems.

Advantages of embodiments of the present disclosure include low power consumption, simple manufacturing techniques, and reliable operation.

Embodiments may also have particular applicability in the technology of edge computing/sensing, where printed devices and large feature sizes are common.

### Biological Waveform Similarity and Applications

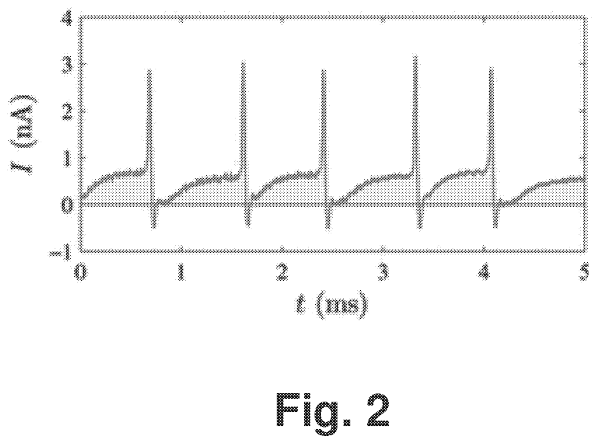

Transmitting signals from electronic systems to biological systems requires the electrical signals to be in the form of voltage pulses that mimic the voltage pulses of the biological neurons. CCEPs as disclosed herein have the unique feature that the waveform of voltage pulses that are produced by the CCEPs are similar to the waveform of the voltage pulses from biological neurons. For example, FIG. 2 depicts an example of a typical current output of an electrode in a CCEP system, which the inventors realized is similar to biological action potentials.

The inventors have demonstrated that embodiments of the present disclosure can operate at the same voltages (approximately 100 millivolts (mV)) and current range as biological neurons. Because of these features, embodiments of the present disclosure have applications in the electrical interfaces that transmit information between electronic systems and biological neurons, which have applications in prosthetic devices, treatments and entertainment.

Embodiments of the present disclosure include a CCEP device comprising one or more of the following:
particles inside a liquid channel in which the number of particles in the channel can range from 1 to 1,000,000;
particles with sizes that range from 1 nanometer (nm) to 10 micrometers (μm);
particles with a largest dimension less than the gap distance between two electrodes, less than 70% of the gap distance, and/or less than 20% of the gap distance;
modulating the operational voltage, frequency and/or stochasticity of the oscillation by changing the size and concentration of particles in the channel;
modifying the attraction of the particles to the electrodes by modifying the surface properties, such as surface energy and roughness, of the particles;
particles with aspect ratios from 1 to 1,000;
particles comprising carbon black, silver coated glass spheres, and/or metals;
two-phase particles (e.g., a bead of water in oil);
particles of different sizes and shapes in the medium occupying the space between two electrodes;
non-smooth (rough) particles and/or particles with large aspect ratios producing devices with low operation voltage and/or low stochasticity;
parallel electrodes, wherein the parallel electrodes enable uniform electric fields and large numbers of particles in the channel; and
in-plane electrodes, wherein the in-plane electrodes increase the electric field per voltage and reduce the operational voltage.

Embodiments of the present disclosure include a circuit created from CCEP oscillators that include one or more of the following:
two or more CCEP oscillators coupled together through external electrical components (e.g., capacitors); and
two or more CCEP oscillators coupled together through different external components (e.g., resistors).

Further embodiments of the present disclosure include one or more of the following:
random number generators (which may be stochastic single oscillators used as random number generators), one example including an oscillator where the time between voltage spikes varies randomly, and the random number generators may be used in encryption devices or hardware-based AI chips;
non-stochastic oscillators (e.g., non-stochastic single oscillators) used as clocks, which may be used in printed electronics or as oscillators for frequency-encoded signals;
single oscillators used to generate bio-compatible electrical signals, which may be used for interfacing with electrically-excitable tissues such as neurons and cardiac cells; and
coupled oscillators used to compute solutions to challenging or nonlinear problems.

Advantages of embodiments of the present disclosure include the ability to perform reservoir type computing by connecting several oscillators 100 and coupling the non-linear elements of the oscillators together. In some embodiments, spintronics type computing can be accomplished.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### ELEMENT NUMBERING

Table 1 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 1

| | |
|---|---|
| 101 | oscillator |
| 102 | oscillator |
| 103 | oscillator |
| 110 | electrode |
| 112 | tip |
| 114 | radius |
| 120 | electrode |
| 122 | tip |
| 124 | radius |
| 130 | particle |
| 131 | particle |
| 131′ | mobile particle |
| 132 | irregularly-shaped particle |
| 133 | largest dimension |
| 135 | compound |
| 136 | particle group |
| 138 | gap |
| 139 | distance |
| 140 | medium |
| 150 | electrical connections |
| 152 | capacitor |
| 153 | capacitor |
| 154 | capacitor |
| 160 | driver |

What is claimed is:

1. An apparatus, comprising:
two first electrodes, wherein each first electrode defines a first electrode tip, and each first electrode tip defines a first electrode tip radius of curvature, wherein the first electrode tips are positioned a first inter-electrode distance from one another, and wherein the first electrode tip radius of curvature of at least one of the first electrodes is no greater than 10 (ten) times the first inter-electrode distance, and wherein each of the first two electrodes is configured to be connected to a first electrical driver capable of applying a voltage difference to the two first electrodes;
a first linearly dielectric fluid filling the space between the two first electrodes; and
one or more first particles contained within the linearly dielectric fluid and configured to be charged by at least one of the two first electrodes, wherein each of the one or more first particles defines a largest particle dimension; and wherein the largest particle dimension each of the one or more first particles is less than the inter-electrode distance.

2. The apparatus of claim 1, wherein at least one of the one or more first particles is non-spherically shaped.

3. The apparatus of claim 1, wherein the one or more first particles are configured to be discharged by at least one of the two first electrodes.

4. The apparatus of claim 1, further comprising:
an electrical measurement device configured to detect changes in
the voltage of at least one of the two first electrode or
the current flowing through at least one of the two first electrodes.

5. The apparatus of claim 1, further comprising:
an optical measurement device configured to detect the motion of the one or more first particles as the one or more first particles moves within the first linearly dielectric fluid.

6. The apparatus of claim 1, further comprising:
an electrical driver connected to the two first electrodes and configured to apply a voltage difference to the two first electrodes.

7. The apparatus of claim 1, wherein
particles with sizes that range from 1 nanometer (nm) to 10 micrometer (μm);
the largest particle dimension is 10 micrometers (μm) or less, and
the electrical driver applies 20 volts or less to each of the first two electrodes.

8. The apparatus of claim 1, further comprising:
an electrical driver connected to the two first electrodes and configured to apply a voltage difference to the two first electrodes, and
an electrical measurement device configured to detect changes in
the voltage of at least one of the two first electrode or
the current flowing through at least one of the two first electrodes;
wherein
the one or more first particles are configured to be discharged by at least one of the two first electrodes,
the particles have largest dimensions greater than or equal to 1 nanometer (nm) and less than or equal to 10 micrometers (μm), and
the electrical driver applies 20 volts or less to each of the first two electrodes.

9. The apparatus of claim 1, further comprising:
two second electrodes, wherein each second electrode defines a second electrode tip, and each second electrode tip defines a second electrode tip radius of curvature, wherein the second electrode tips are positioned a second inter-electrode distance from one another, and wherein the second electrode tip radius of curvature of at least one of the second electrodes is no greater than 10 (ten) times the second inter-electrode distance, and wherein each of the second two electrodes is configured to be connected to a second electrical driver capable of applying a voltage difference to the two second electrodes, and wherein the two second electrodes are configured to electrically or magnetically interact with the two first electrodes;
a second linearly dielectric fluid filling the space between the two second electrodes; and
one or more second particles contained within the linearly dielectric fluid and configured to be charged by at least one of the two second electrodes, wherein each of the one or more second particles defines a largest particle dimension; and wherein the largest particle dimension each of the one or more second particles is less than the inter-electrode distance.

10. The apparatus of claim 9, wherein the two second electrodes electrically or magnetically interact with the two first electrodes by
there being an electrical connection between at least one of the two second electrodes and at least one of the two first electrodes and
the electrical connection including at least one capacitor.

11. The apparatus of claim 9, wherein the two second electrodes electrically or magnetically interact with the two first electrodes by
at least one of the two second electrodes being positioned sufficiently close to at least one of the two first electrodes to magnetically interact with the at least one of the two first electrodes during operation.

12. The apparatus of claim 9, wherein
the space between the two first electrode tips and space between the two second electrode tips are in fluidic communication with one another, and
the space between the two first electrode tips and the space between the two second electrode tips is filled with the same linearly dielectric fluid.

13. A method of forming an oscillator, comprising:
positioning two first electrodes within a first linearly dielectric fluid and at an inter-electrode distance from one another, wherein
the two first electrodes are configured to connect to an electrode driver configured to place the first electrodes at different voltages,
each of the two first electrodes defines a first electrode tip,
the first electrode tip defines a first electrode tip radius of curvature, and
the inter-electrode distance is no greater than 10 (ten) times the first electrode tip radius of curvature; and
positioning at least one first particle within the first linearly dielectric fluid, wherein
the at least one first particle is configured to hold an electrical charge,
the at least one first particle defines a first particle largest dimension, and
the first particle largest dimension is less than the inter-electrode distance.

14. The method of claim 13, further comprising:
connecting the first electrodes to a driver, and
placing the first electrodes at different voltages with the driver, wherein the different voltages have a baseline of 2 volts or less.

15. The method of claim 13, further comprising:
positioning two second electrodes within a second linearly dielectric fluid and at an inter-electrode distance from one another, wherein
the two second electrodes are configured to connect to the electrode driver configured to place the second electrodes at different voltages,
each of the two second electrodes defines a second electrode tip,
the second electrode tip defines a second electrode tip radius of curvature, and
the inter-electrode distance is no greater than 10 (ten) times the second electrode tip radius of curvature; and
positioning at least one second particle within the second linearly dielectric fluid, wherein
the at least one second particle is configured to hold an electrical charge,
the at least one second particle defines a second particle largest dimension, and
the second particle largest dimension is less than the inter-electrode distance.

16. The method of claim 15, wherein the first linearly dielectric fluid and the second linearly dielectric fluid are mixed with one another.

17. The method of claim 15, further comprising:
connecting the two first electrodes to the two second electrodes with a capacitor.

18. The method of claim 15, further comprising:
connecting the first electrodes to a driver,
connecting the second electrodes to a driver,
placing the first electrodes at different voltages with the driver, and
placing the second electrodes at different voltages with the driver.

19. The method of claim 13, further comprising:
connecting the two first electrodes to the two second electrodes with a capacitor;
connecting the first electrodes to a driver;
connecting the second electrodes to a driver;
placing the first electrodes at different voltages with the driver; and
placing the second electrodes at different voltages with the driver;
wherein the first linearly dielectric fluid and the second linearly dielectric fluid are mixed with one another.
